(19) United States
(12) Patent Application Publication
(10) Pub. No.: US 2009/0006448 A1
(43) Pub. Date: Jan. 1, 2009

(54) AUTOMATED MODEL GENERATOR

(75) Inventors: Gurdeep Singh Pall, Medina, WA (US); Christopher H. Pratley, Seattle, WA (US); Lewis C. Levin, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/770,700

(22) Filed: Jun. 28, 2007

(51) Int. Cl. G06F 17/00; G06F 7/00

(52) U.S. Cl. 707/102

(57) ABSTRACT

A model generation system is provided. The system includes a monitor component to determine user actions and gestures during computer operations. A model component automatically infers a model from the user actions and gestures, where the model is employed to generate a schema in order to provide context for an application or data structure.

### BACKGROUND

Schemas are an important component in modern software development. Such schemas are often expressed in an Extensible Markup Language (XML) for example but other schema languages are possible. For instance, XML Schemas express shared vocabularies and allow machines to carry out rules made by people. They provide a means for defining the structure, content and semantics of XML documents in more detail. Presently, schemas are mainly constructed by hand where a schema designer will define and organize the various components that may appear in a given schema.

Typically, the purpose of a schema is to define a class of XML documents, and thus the term “instance document” is often used to describe an XML document that conforms to a particular schema. In fact, neither instances nor schemas need to exist as documents per se—they may exist as streams of bytes sent between applications, as fields in a database record, or as collections of XML “Information Items,” for example. Instances and schemas are often referred to as if they are documents and files but can be other forms as noted.

The schema generally consists of a schema element and a variety of sub-elements, most notably element, complexType, and simpleType which determine the appearance of elements and their content in instance documents. Each of the elements in the schema has a prefix xsd: which is associated with the XML Schema namespace through the declaration, for example xmlns:xsd=“http://www.w3.org/2001/XMLSchema”, that appears in the schema element. The prefix xsd: is used by convention to denote the XML Schema namespace, although any prefix can be used. The same prefix, and hence the same association, also appears on the names of built-in simple types, e.g., xsd:string. The purpose of the association is to identify the elements and simple types as belonging to the vocabulary of the XML Schema language rather than the vocabulary of the schema author.

In XML Schema language, there is a basic difference between complex types which allow elements in their content and may carry attributes, and simple types which cannot have element content and cannot carry attributes. There is also a major distinction between definitions which create new types (both simple and complex), and declarations which enable elements and attributes with specific names and types (both simple and complex) to appear in document instances. New complex types may be defined using a complexType element and such definitions typically contain a set of element declarations, element references, and attribute declarations. The declarations are not themselves types, but rather an association between a name and the constraints which govern the appearance of that name in documents governed by the associated schema.

Although schemas are highly useful in a variety of applications, creating such schemas is still often a highly manual process where the designer defines the respective elements and attributes for applications and creates links to other applications. In one example, the W3C XML Schema language was created by the W3C XML Schema Working Group based on many different submissions from a variety of companies and individuals attempting to satisfy various application needs. While providing a basis to further application development, schema ontologies have become complicated to deal with instances, where models more aptly provide a shorthand processing form, are more conceptual, and provide an abstraction. Presently, automated techniques for generating such models and schemas are needed.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Models are automatically generated that incorporate a higher level of schema generation for inferring context of an application. In general, a model is generated that is based off of the content of a document rather than the format or document structure such as in traditional schema-based models. The models can be employed to automatically generate schemas that can be utilized for other applications. The models can be inferred from a variety of actions such as from queries, profiles, actions, frequency of use and so forth. Such models can be utilized to understand data and its associated contexts when a user is not the creator of the given document. This allows leveraging to build other applications from previous work. Models can be associated with schemas, where model inferences allow auto tagging of documents since humans generally do not want to perform such actions. This can include monitoring people's gestures and implying a model by human actions. The power of the model is not caught up in the detail of more complicated ontologies, where inference patterns of human behavior can be employed to generate the respective models.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a model generation system.

FIG. 2 is a block diagram that illustrates a model component and data analysis system.

FIG. 3 illustrates a system for viewing contextual data that can be automatically associated with an application or data structure.

FIG. 4 illustrates a transform component and model interactions.

FIG. 5 illustrates an example user profile that can be employed to control summary generation.

FIG. 6 illustrates auto tagging of data structures from models.

FIG. 7 illustrates data synchronization between models and applications.

FIG. 8 illustrates a general process for automatically generating models.

FIG. 9 illustrates a data synchronization process for models.

FIG. 10 is a schematic block diagram illustrating a suitable operating environment.

FIG. 11 is a schematic block diagram of a sample-computing environment.

### DETAILED DESCRIPTION

Systems and methods are provided for automatically generating models and adding context to documents in order to facilitate collaboration with other users of the document or file. In one aspect, a model generation system is provided. The system includes a monitor component to determine user actions and gestures during computer operations. A model component automatically infers a model from the user actions and gestures, where the model is employed to generate a schema in order to provide context for an application or data structure.

As used in this application, the terms “component,” “application,” “model,” “schema,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g. data from one component interacting with another component in a local system, distributed system, and/or across a network such as the Internet with other systems via the signal).

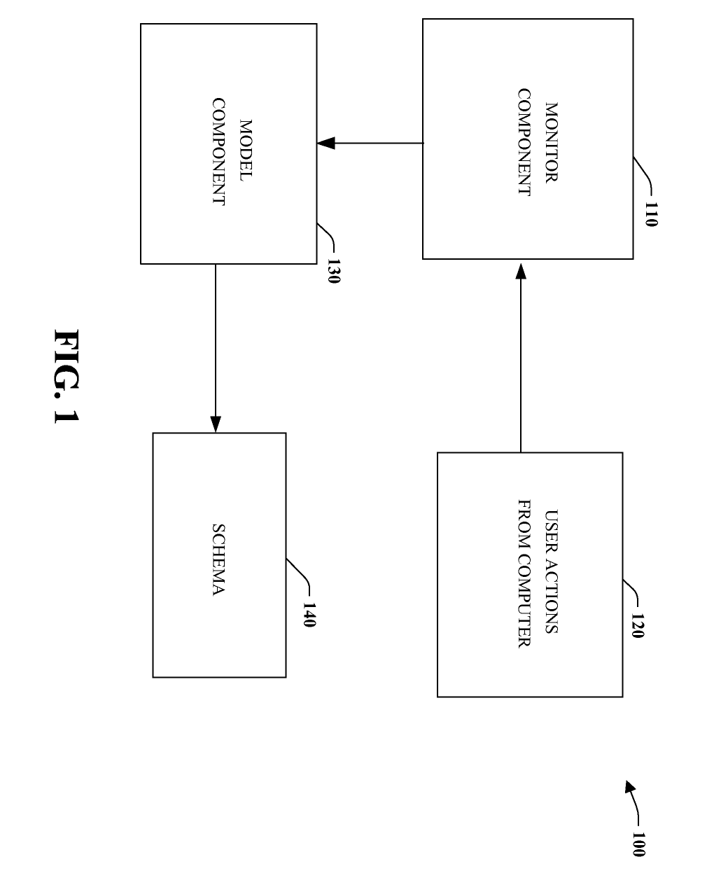

Referring initially to FIG. 1, a system 100 is illustrated for automatically generating models for application development. The system 100 includes a monitor component 110 that monitors or determines user actions at a computer or device 120. The actions monitored at 110 include substantially any type of activity that may indicate a context for applications and associated data created or manipulated on the computer 120. This can include monitoring voice communications, keyboard actions, facial monitoring, meeting notes, program comments, design review comments and so forth. From these actions, relevant context can be determined, where a model component 130 (also referred to as models) communicates with the monitor component 110 and automatically generates a schema 140 that captures the context. For instance, the modeled context can include how data structures are related to one another, how one portion of code is to be linked or interfaced with another yet unavailable portion of code, why a data structure is defined, the reasoning behind overall application design or reasoning behind particular code portions and so forth. From the captured context of the model component 120, the schema 140 can automatically reflect information that can be leveraged by other designers of the application and associated data structures.

In general, models at 130 are automatically generated that incorporate a higher level of schema generation at 140 for inferring context of an application. Thus, a model can be generated that is based off of the content of a document rather than the format or document structure such as in traditional schema-based models. The models 130 can be employed to automatically generate schemas 140 that can be utilized for other applications. The models 130 can be inferred from a variety of actions such as from queries, user profiles, actions, frequency of use and so forth. Such models 130 can be utilized to understand data and its associated contexts when a user is not the creator of the given document. For example, if a subsequent designer were to receive a portion of initial code from a first designer, the subsequent designer can inspect the relevant data/application contexts in the creating of the initial code. This allows leveraging to build other applications from previous work. Models 130 can be associated with schemas 140, where model inferences allow auto tagging of documents since humans generally do not want to perform such actions. This can include monitoring people's gestures at 120 and implying the model 130 in accordance with human actions.

Other aspects of the system 100 include model-viewing where documents are pivot-able for performing different renderings, mapping transforms, connected images, cascaded documents, and updating synchronizing data structures. Interfaces can be provided for viewing hierarchies of texts, charting, what are the abstract properties that allow one to use data in a particular way, supporting multiple views, where pivot-able allows viewing different renderings of the data since the model 130 is known. Mapping transforms allows equating language nuances across domains. Content models model goals, plans, objectives, and model inference. For instance, if one starts with the same type of opening paragraph, uses a particular type of prose, infers aspects since users perform certain things repetitively, allows flow from a word document to auto generate a power point slide for example, where procedure code obscures the purpose of the models 130. The declarative definitions of models 130 allow transforms between applications, turning documents into presentations, turning mail messages into documents, providing synchronization of updates such as linking by knowledge of model.

Modeling of data content allows one to know what may be important in a spread sheet and how that may apply to a word document for example, where the models allow one to know how to relate applications without knowing the content of the document, keeping track of relationships between applications and models, and allowing data synchronization between applications. User patterns 120 can be modeled such as copy and pasting over time generates models, queries run over time, and other patterns that can be detected. Reading-based model generation can include observing what people are reading to supplement models, and using eye-tracking cameras to detect what is of interest to the user. Other aspects can include storing entire user history for models, studying the past actions and storing the patterns, detecting a link between data structures and asking users if they want to maintain synchronization link or not between data structures. Other monitoring for developing models include monitoring for typing biometrics such as monitoring how users are inputting data to further develop the models 130, analyzing typing patterns and relating to a user's profile. In another aspect, the system 100 provides a model generator system. This includes means for capturing (monitor component 110) one or more user activities 120. The system 100 also includes means for analyzing the user activities and updating (model component 130) at least one data structure in view of the activities. This also includes means for storing updates (schema 140) from the data structure.

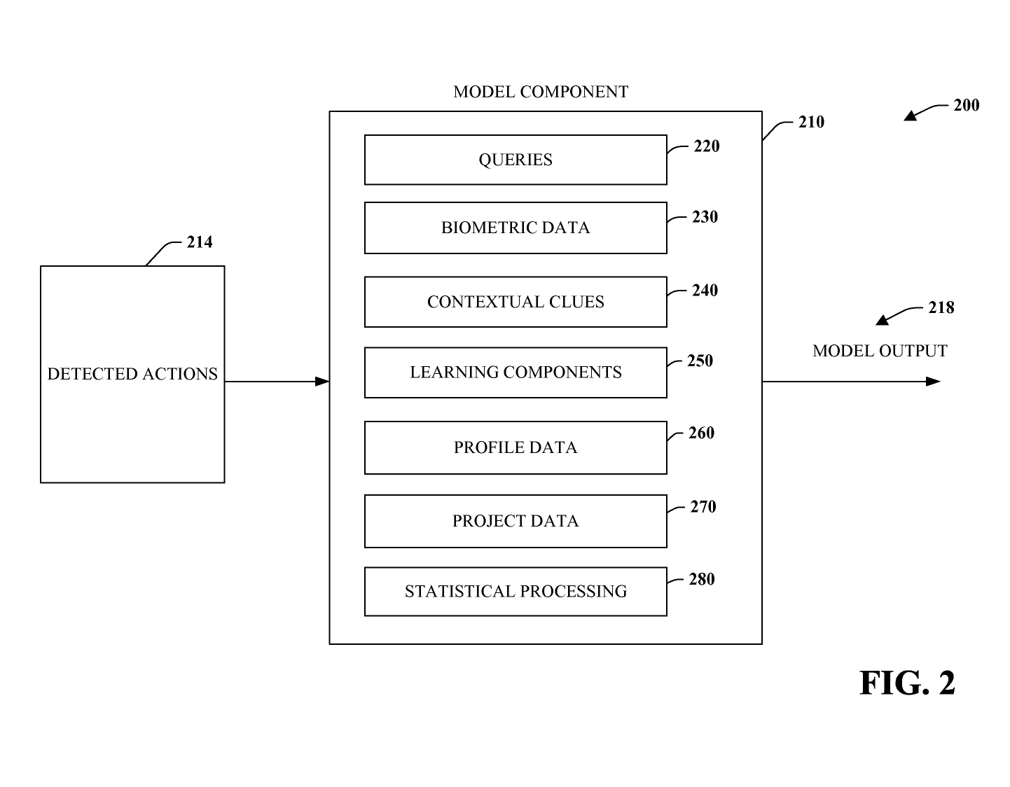

Referring now to FIG. 2, a system 200 and model component 210 for analyzing user data is illustrated. The model component 210 analyzes user actions 214 such as have been previously detected by a monitor component described above and automatically produces model output 218. The model component 210 shows example factors that may be employed to analyze data to produce the output 218. It is to be appreciated that substantially any component that analyzes actions or history data at 214 to automatically generate model output at 218 can be employed.

Proceeding to 220, one aspect for modeling user actions includes monitoring queries that a respective user may make. This may include local database searches for information in relation to a given data structure where such query data (e.g., key words employed for search) can be employed to potentially add context to a given data structure or application under development. For example, if a search were being conducted for the related links to a data structure, the recovered links may be used to further document a current data structure (or structures) under design. Remote queries 220 can be processed such as from the Internet where data learned or derived from a respective query can be used to add context to a data structure or application.

At 230, biometric data may be analyzed. This can include analyzing keystrokes, audio inputs, facial patterns, biological inputs, and so forth that may provide clues as to how important a given piece of data is to another and based how a user or designer processes the data (e.g., spending more time analyzing a component may indicate more importance). For example, if a user were designing a sales document for automobiles and three different competitors were concurrently analyzed, contextual data relating to the competitors analyzed can be automatically captured by the model component 210 and saved to indicate the analysis. Such contextual data can be recovered and added to a schema that later employs the document where it may be useful to know how such data was derived.

At 240, one or more contextual clues may be analyzed. Contextual clues can be any type of data that is captured that further indicates processing of a data structure. For example, one data structure designed for a current application may have been constructed from two other data structures. One type of contextual data would be to automatically document the original data structures employed and perhaps providing links or addresses to the structures. This may also include noting that one of the structures was merely used as a shell application (e.g., used for template and not content) whereas another structure was employed because the content of the structure was highly relevant to the current software design.

At 250, one or more learning components can be employed by the model component 210 to generate output 218. This can include substantially any type of learning process that monitors activities over time to determine how to annotate, document, or tag data in the future. For example, a user could be monitored for such aspects as where in a document they analyze first, where their eyes tend to gaze, how much time they spend reading near key words and so forth, where the learning components 250 are trained over time to capture contextual nuances of the user. The learning components 250 can also be fed with predetermined data such as controls that weight such aspects as key words or word clues that may influence the model component 210. Learning components 250 can include substantially any type of artificial intelligence component including neural networks, Bayesian components, Hidden Markov Models, Classifiers such as Support Vector Machines and so forth.

At 260, profile data can influence how model output is generated at 218. For example, controls can be specified in a user profile that guides the model component 210 in its decision regarding what should and should not be included in the output 218. In a specific example, a systems designer specified by profile data 260 may be responsible for designing data structures that outline code in a more high level form such as in pseudo code. Any references to specific data structure indicated by the pseudo code may be noted but not specifically tagged to the higher level code assertions. Another type of user may indicate they are an applications designer and thus have preferences to capture more contextual details for the underlying structures. Still yet other type of profile data can indicate that minimal contextual data is to be captured in one context where maximal data is to be captured in another context. Such captured data can later be tagged to applications and data structures to indicate to other users what the relevant contexts were when the code was developed.

At 270, substantially any type of project data can be captured and potentially used to add context to an application or data structure. This may include design notes, files, schematics, drawings, comments, e-mails, presentation slides, or other communication. This could also include audio or video data from a meeting for example where such data could be linked to a data structure. For example, when a particular data structure is tagged as having meeting data associated with it, a subsequent user could select the link and pull up a meeting that was conducted previously to discuss the given data structure of application. As can be appreciated, substantially any type of data can be referenced from a given tag or tags if more than one type of data is linked to a given data structure.

At 280, substantially any type of statistical process can be employed to generate model output 218. This can include monitoring certain types of words such as key words for example for their frequency in a document or paragraph, for word nearness or distance to other words in a paragraph (or other media), or substantially any type of statistical processes that is employed to indicate additional context for a processed application or data structure. As can be appreciated, substantially any type of data that is processed by a user can be modeled at 210 and subsequently employed to add context to the application or data structure at 218.

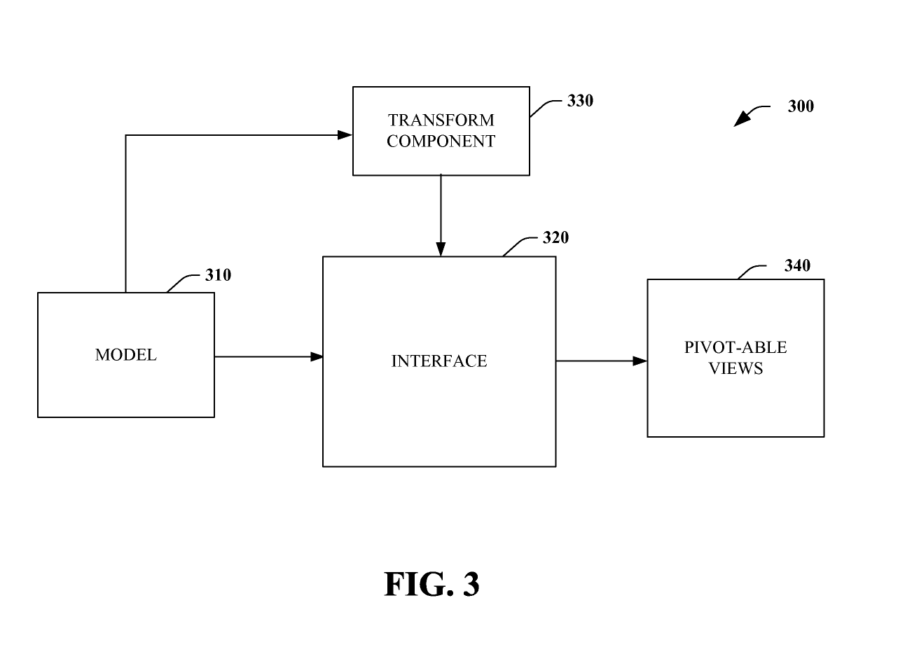

Turning to FIG. 3, a system 300 for viewing contextual data is illustrated. In this aspect, a model 310 as previously described, drives an interface 320 and a transform component 330 to generate one or more pivot-able views of data at 340. As will be described in more detail below, the transform component 330 can take data in one form and automatically recreate the data in another form. For instance, data structures designed to drive a text document could be converted to an HTML form for web viewing or to an image form (e.g., PDF) for other type display of the respective text. The interface component 320 can monitor outputs from the model component 310 and/or the transform component 330 to determine what type of view to provide at 340. This may include a dimensional view such as associated with a data cube, a layout view such as associated with a schema, or a display view such as associated with a graphical presentation for example. Along with views at 340, other sensor outputs such as sounds can be driven to highlight or accent a particular view.

Other aspects of the system 300 include model-viewing where documents are pivot-able at 340 for performing different renderings of data structures. This can include providing mapping transforms, showing connected images, providing cascaded documents, and updating or synchronizing data structures as will be described in more detail below. Interfaces 320 can be provided for viewing hierarchies of texts, charting data, and determining what are the abstract properties that allow one to use data in a particular manner supporting multiple views at 340 where pivot-able functionality allows viewing different renderings of the data since the model 310 is known.

Various controls can be provided with the interface 320 that allow users to tailor how viewing output at 340 is generated and presented to the respective user. In one example, a length control can be provided that regulates how large or small a given output can be at 340. This can include specifying a file size or other parameter such as word length, page length, paragraph constraints and so forth. One or more output preferences can be specified via the interface 320. This can include specifying font sizes, colors, audio levels, output display size or display real estate requirements for example. Other types of preferences may include enabling or disabling the types of media that may be included in a respective view 340 such as text, audio, video and so forth.

Processing time can be a parameter to control output generation. In this case, display generation components may display more accuracy or be better suited to a user's viewing preferences if more processing time is spent. In other cases, speed is of the essence where accuracy in generation of the output can be potentially traded off. Thumbnail generation controls can be provided. This can include controlling the look and form of viewing output at 340. For instance, a text document can be reduced to a small display area where auto generated text is included in the thumbnail. For more formal presentations, thumbnail options may be disabled where paragraphs or text is shown at 340 in a larger or different form than a small thumbnail view. As can be appreciated, audio or video thumbnails can also be specified and controlled.

The interface 320 can be served from a remote server or on a respective mobile device if desired. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating the views 340 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user.

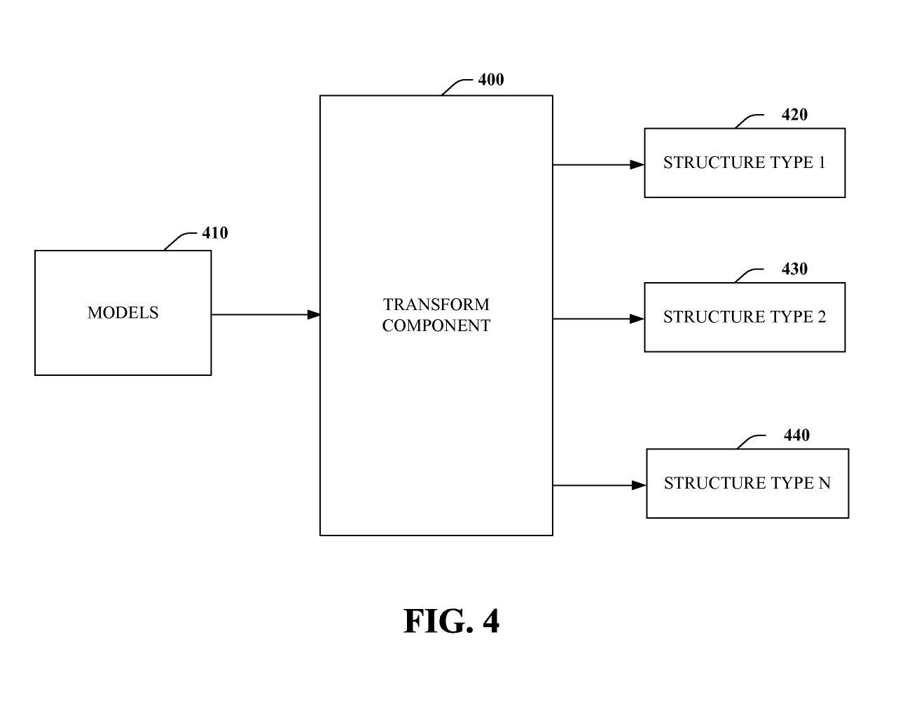

Turning to FIG. 4, a transform component 400 and model interaction is illustrated. The transform component 400 receives data from one or more models 410. Such data can be in substantially any format including textual forms such as XML or HTML or other forms such as audio files, image files, spreadsheet files, presentation slides and so forth. The transform component 400 provides a mapping to convert data in one form to substantially any other form as varying structure types at 420 through 440. This can include converting more than one form of model data 410 to multiple forms of data structures at 420-440. This can also include converting a singular form of data from the model 410 to multiple different structure types 420 to 440. For example, this can include creating multiple views of data as previously described with respect to FIG. 3.

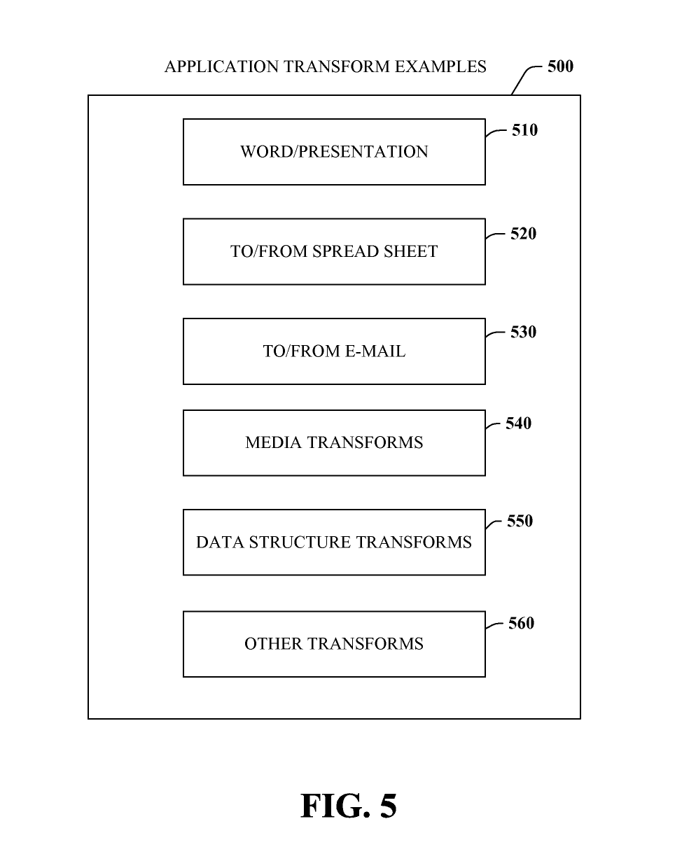

The transform component 400 can include various mapping components in one aspect. For example, one mapping could convert numeric data into an XML format that represents such data. A universal mapping algorithm could be applied where model data from the models 410 is analyzed and subsequently processed by the algorithm for the desired output or outputs at 420 though 440 if necessary. Along with model data, the models 410 can communicate desired output mappings to the transform component 400. In another aspect, mapping components may be split amongst several processors or algorithms. For instance one mapping component may be designated for one specific type of mapping from an input form to an output form whereas another type of mapping component may process a different input-to-output mapping. Various example transforms will now be described with respect to FIG. 5 below.

Proceeding to FIG. 5, application transform examples 500 are illustrated. As noted previously, mapping transforms allows equating language or data nuances across domains. In the abstract, data content models can be employed to model user goals, plans, objectives, and can be inferred from monitored circumstances. For instance, if one starts with the same type of opening paragraph or employs a particular type of prose, then aspects of such patterns can be detected since users perform certain things repetitively. Thus, often times what a user performs in one context is relevant or related to another context, where a transform component allows mapping of data between such contexts.

Referring to the examples 500, one type of transform at 510 can allow data generated for a word document to auto generate a presentation slide (e.g., power point) for example. As can be appreciated, if a user were working on a presentation, data could be transformed in the reverse to the word style for future employment with other applications or models. As shown, another type of application transform that may occur could be to or from a spreadsheet form 520 or e-mail form 530 that is automatically applied to another application or model. For example, if an e-mail were received describing a change to a particular code design, the e-mail could be captured in text, converted and transformed to XML, and automatically inserted as XML commentary in a schema to enhance the context behind a particular code development.

At 540, media transforms can occur. This can be audio, video, image or other data that is captured in one form, transformed into another form and inserted or referenced by another model. For instance, a phone conversation may be captured and a link is captured by the model, such that if the particular code section were referenced, the link could be selected to replay the conversation. In another case, the audio could be converted to text at 540 and applied to an existing model for later contextual awareness of the respective model. At 550 one or more data structure transforms can be provided along with substantially any other type of transform at 560 that converts data in one form in accordance with at least one other form suitable for a model that employs such data. As noted previously, declarative definitions of models allow transforms between applications, turning documents into presentations, turning mail messages into documents, providing synchronization of updates such as linking by knowledge of the respective model, where synchronization aspects between models and data structures are described in more detail below.

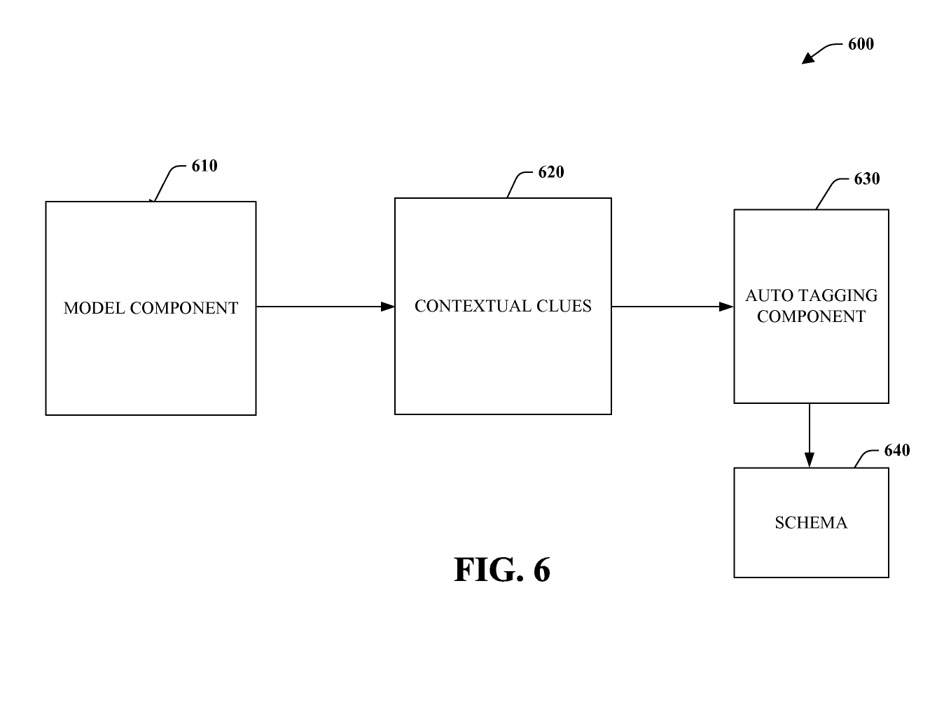

Referring now to FIG. 6, a system 600 illustrates auto tagging of data structures from models. In many cases, the models previously described can be employed to add further context to existing works, other models, schemas, code portions and so forth. Thus, a model component 610 that has captured some type of data context can transmit data in the form of contextual clues 620 to an auto tagging component 630 which annotates the clues within a given schema 640 for example. Thus, if some data were captured by the model 610 relating to a given data structure or application, such data could be transported in the form of one or more contextual clues 620. Although not shown, such data could be transformed to a different type of data structure before being transmitted to the auto tagging component 630. Upon receipt of such data, the auto tagging component 630 appends, annotates, updates, or otherwise modifies a schema to reflect the contextual clues 620 captured by the respective model component 610.

In one example, the model component 610 may learn (from learning component) that the user has just received instructions for upgrading a presentation algorithm with a latest software revision. As the revision is being implemented, a contextual clue 620 relating to the revision could be transmitted to the auto tagging component 630, where the schema 640 is then automatically updated with a comment to note the revision. If a subsequent designer were to employ the schema 640, there would be little doubt at which revisions were employed to generate the schema. As can be appreciated, contextual clues 620 can be captured for other activities that noting a revision in a document. These can include design considerations, interface nuances, functionality considerations, code limitations, data structure design requirements, and so forth.

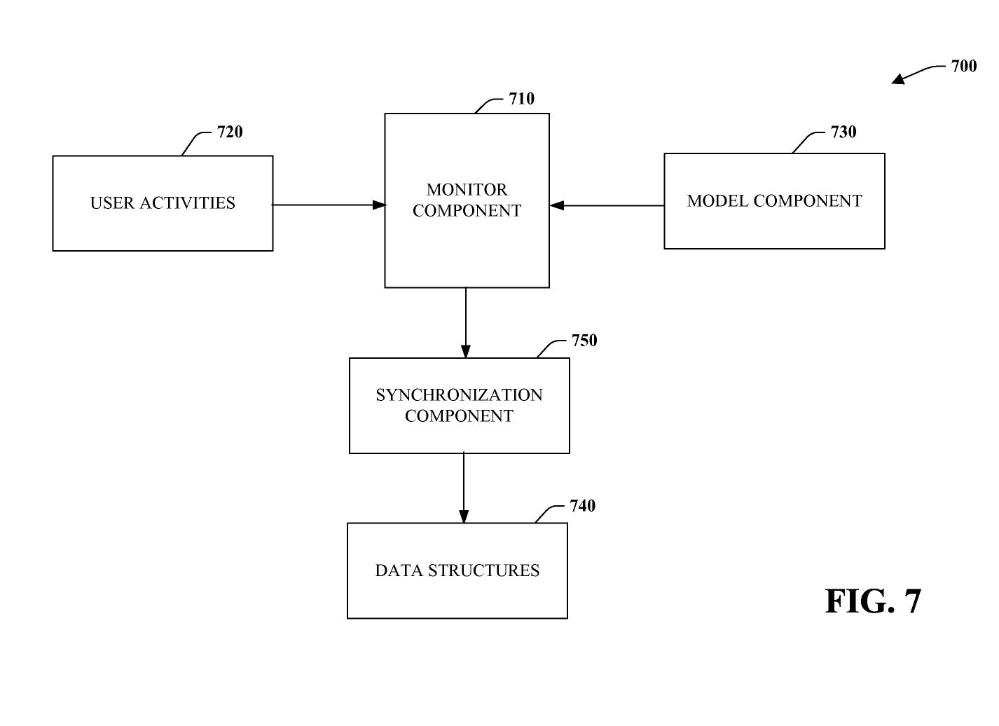

Referring to FIG. 7, a system 700 illustrates data synchronization between models and applications. A monitor component 710 analyzes observes user activities 720 over time. In accordance with such monitoring, one or more model components 730 that have been trained or configured previously are also processed by the monitor component 710. In some cases, a change in the user activities 720 may be detected where the model component 730 is updated and/or automatically adjusted. In such cases, it may be desirable to update or synchronize other data structures 740 that have previously been modified by the model component 730. As shown, a synchronization component 750 can be provided to automatically propagate a detected change to the data structures 740. Although not shown, rather than allowing automatic updates to occur in the data structures 740, the synchronization component 750 could invoke a user interface to inquire whether or not the user desires such synchronization.

As noted previously, other aspects can include storing entire user history for the model components 730, analyzing past actions over time, storing the patterns, detecting a link between data structures 740 and querying users if they want to maintain synchronization link or not between the data structures. Other monitoring for developing model components 730 include monitoring for typing biometrics such as monitoring how users are inputting data to further develop the models, analyzing the typing patterns and relating to a user's profile. If such data were to be considered relevant to the data structures via processing determinations, then further synchronization between structures could be performed.

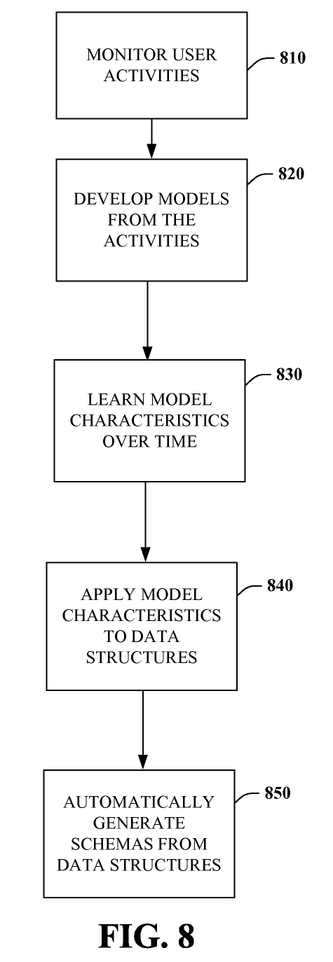

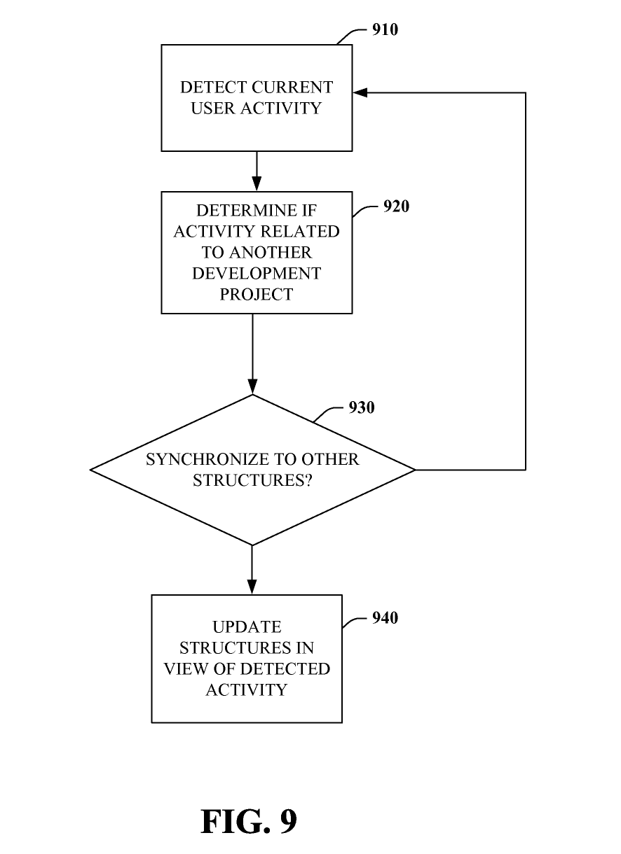

FIGS. 8 and 9 illustrate exemplary processes for automatically generating model data. While, for purposes of simplicity of explanation, the processes are shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

FIG. 8 illustrates a general process for automatically generating models. Proceeding to 810, user activities are monitored over time. This can include monitoring computer processes such as keyboard inputs, audio or video inputs, phone conversations, meetings, e-mails, instant messages, or other biofeedback devices to capture user intentions and context. At 820, one or more models are developed from the detected activities at 810. Such models could be learning models such as a classifier that statistically determines such aspects as whether or not a present user action is related to a given data structure. For example, certain prose may be detected that indicates a designer is implementing a certain type of function. Upon such detection, the models can determine that there may be other related applications, functions, or documents that can benefit from knowing about the users current work. This may include quizzing the user about related functions and determining whether or not such work is relevant to the current application. Similarly, the prose may trigger an e-mail (or other communication) to be automatically be generated to let other developers know of the current activity.

At 830, model characteristics can be learned over time. In the case of learning components such as Bayesian networks, monitored activities can be employed to train/modify the networks over time. Users can also be part of the training process where they offer feedback to modify algorithms or other learning processes. At 840, the learned model characteristics are applied to one or more data structures. Thus, if a user pattern were detected, the model characteristics can be automatically employed to generate or modify a schema or other document in view of the detected patterns or activities.

Referring to FIG. 9, a data synchronization process for models is illustrated. Proceeding to 910, the process automatically detects current user activities. As noted above, one or more monitor components can be employed to trace user actions. This can include monitoring via one or more input devices associated with a user and couple to one or more computing devices to record/detect such activities. At 920, a determination is made as to whether or not the detected activity is related to another development project or data structure. If such the detection is made, the process proceeds to 930. At 930, a determination is made as to whether or not data synchronization should be performed. In some cases, automatic synchronizations can occur. In other cases, users can be queried whether or not to perform the synchronization. If the synchronization is not to be performed at 930, the process proceeds back to 910 to detect other activities. If the synchronization is to be performed at 930, the process proceeds to 940 and updates one or more data structures, files, or applications in view of the detected activities of 910.

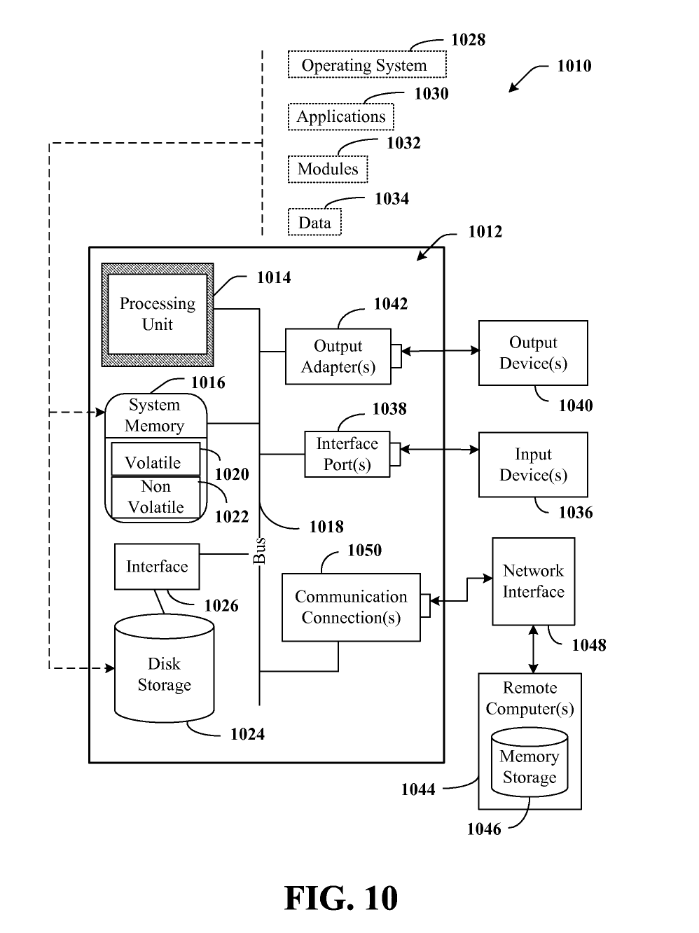

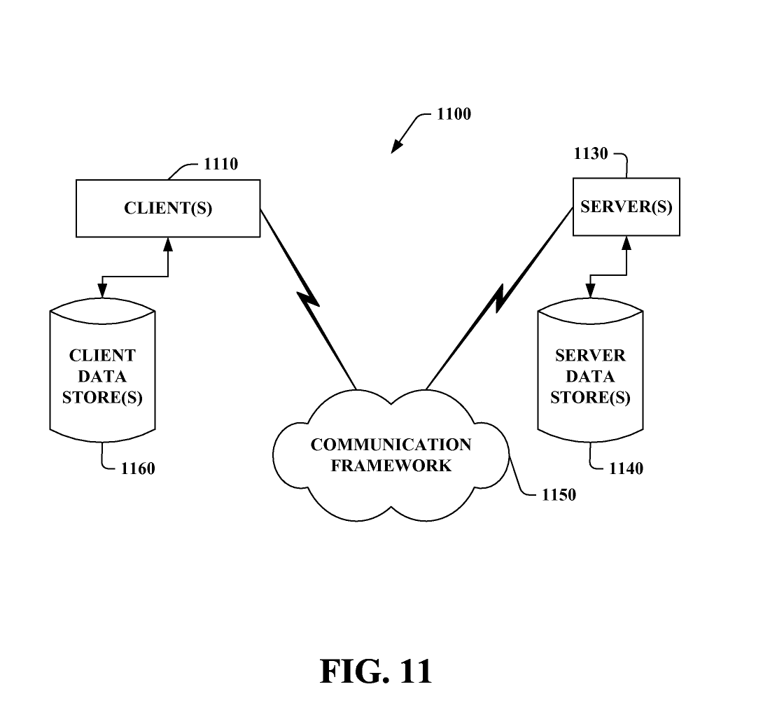

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects described herein includes a computer 1012. The computer 1012 includes a processing unit 1014, a system memory 1016, and a system bus 1018. The system bus 1018 couple system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, multi-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g. threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 11130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A model generation system, comprising:
a monitor component to determine user actions and gestures during computer operations; and
a model component to automatically infer a model from the user actions and gestures, where the model is employed to generate a schema in order to provide context for an application or data structure.

2. The system of claim 1, the model component employs document content to generate context for the schema.

3. The system of claim 1, the user actions are inferred from queries, user profiles, frequency of use, biometric data, project data, and statistical processing.

4. The system of claim 1, the model components are associated with one or more learning components.

5. The system of claim 1, further comprising an interface component to facilitate different renderings of data structures.

6. The system of claim 1, the renderings are associated with one or more mapping transforms, dimensional views of data, connected images, or cascaded documents.

7. The system of claim 5, the interface component allows viewing of hierarchies of texts, data charting, views of abstract properties, or multiple data views.

8. The system of claim 1, further comprising an auto tagging component to apply detected data contexts to a data structure or application.

9. The system of claim 1, further comprising a transform component to map data in one format to at least one other format.

10. The system of claim 9, the transform component maps textual data, presentation data, e-mail data, or media data.

11. The system of claim 9, transform component maps captured contextual data into an XML schema.

12. The system of claim 1, further comprising a synchronization component to update data structures in view of detected activities.

13. The system of claim 12, the synchronization component is associated with an interface to facilitate updating of desired data structures.

14. The system of claim 1, further comprising a media capture component to facilitate context updates to a data structure.

15. The system of claim 1, the media capture component is associated with a voice capture, an image capture, or a video capture.

16. A method to generate model data, comprising:
monitoring computer activities to gather context relating to a data structure or application;
modeling the computer activities to determine the context; and
automatically updating at least one other data structure or application in view of the determined context.

17. The method of claim 16, further comprising synchronizing data structures when monitoring computer activities.

18. The method of claim 16, further comprising transforming data structures between at least two formats when monitoring computer activities.

19. The method of claim 16, further comprising automatically tagging documents in view of the determined context.

20. A model generator system, comprising:
means for capturing one or more user activities;
means for analyzing the user activities and updating at least one data structure in view of the activities; and
means for storing updates from the data structure.
